(19) United States
(12) Patent Application Publication
(10) Pub. No.: US 2025/0319758 A1
(43) Pub. Date: Oct. 16, 2025

(54) MOUNTING ARRANGEMENT AND METHOD FOR MOUNTING A BATTERY MODULE

(71) Applicant: Volvo Truck Corporation, Göteborg (SE)

(72) Inventors: Svetlana LEBEDEVA, MÖLNLYCKE (SE); Fredrik KARSTRÖM, MÖLNLYCKE (SE)

(21) Appl. No.: 19/089,793

(22) Filed: Mar. 25, 2025

(30) Foreign Application Priority Data
Apr. 11, 2024 (EP) 24169781.2

(51) Int. Cl. B60K 1/04; H01M 50/249; H01M 50/262; H01M 50/271

(52) U.S. Cl. CPC B60K 1/04; H01M 50/249; H01M 50/262; H01M 50/271; H01M 2220/20

(57) ABSTRACT

A mounting arrangement for mounting a battery module to a housing of a mounting structure, the mounting arrangement comprises a fastening element adapted to engage the battery module from a first side of the housing facing away from the battery module, a mounting element adapted to be fixed relative to the housing and arranged on a second side of the housing facing the battery module, and a compensating element mounted to the mounting element.

### PRIORITY APPLICATIONS

The present application claims priority to European Patent Application No. 24169781.2, filed on Apr. 11, 2024, and entitled “MOUNTING ARRANGEMENT AND METHOD FOR MOUNTING A BATTERY MODULE,” which is incorporated herein by reference in its entirety.

### TECHNICAL FIELD

The disclosure relates generally to mounting arrangements. In particular aspects, the disclosure relates to a mounting arrangement and method for mounting a battery module to a housing. In particular aspects, the disclosure relates to a mounting arrangement and method for mounting a battery module to a mounting structure. The disclosure can for example be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Within the field of electrically propelled vehicles, large batteries consisting of multiple smaller cells are commonly stacked together to form battery modules. In conventional electrically propelled vehicles, one or more battery modules are often arranged in a stack in a housing, wherein each battery module is slid into its position in the housing. To enable the battery modules to easily slide into position, space is required around the battery module in the housing which is associated with challenges when the battery module is to be fixated relative to the housing in its mounted position due to the fixation often requiring the mating surfaces to be in contact.

To address the aforementioned challenges, brackets or complex fastening systems allowing for bolting in different planes has been utilized.

### SUMMARY

According to a first aspect of the disclosure, a mounting arrangement for mounting a battery module to a housing of a mounting structure is provided. The mounting arrangement comprises a fastening element adapted to engage the battery module from a first side of the housing facing away from the battery module, a mounting element adapted to be fixed relative to the housing and arranged on a second side of the housing facing the battery module, and a compensating element mounted to the mounting element. The compensating element is adapted to abut to an outer surface of the battery module and to be fixated relative to the housing by the fastening element such that the battery module is fixated at a distance from the second side. The first aspect of the disclosure may seek to achieve a simpler manner of mounting a battery module to a mounting structure. A technical benefit may include that the compensating element may allow for a gap between the parts to be compensated prior to battery module being fixated to the mounting structure. Another technical benefit may include that the mounting element and the compensating element can be mounted beforehand and that a gap can be compensated by adjustment from the outer side of the housing making the mounting operation easier, faster and more user friendly.

Optionally in some examples, including in at least one preferred example, the compensating element may comprise an end portion with an end surface adapted to engage the battery module. A technical benefit may include that the compensating element more efficiently may compensate for distances and shifting tolerances of the housing and the battery module.

Optionally in some examples, including in at least one preferred example, the end portion may comprise a flanged portion provided with the end surface. A technical benefit may include that a more cost-efficient mounting arrangement and more flexible mounting arrangement may be achieved as it may be suitable to use in combination with any type of battery module without requiring any modifications of the outer surface of the battery module.

Optionally in some examples, including in at least one preferred example, the end portion may comprise a conical portion provided with the end surface. A technical benefit may include that the conical surface enables a more secure engagement with the battery module and provides a guide for the adjustment of the compensating element.

Optionally in some examples, including in at least one preferred example, the mounting element and the compensating element may be provided with threading such that the compensating element and the mounting element are in adjustable engagement. A technical benefit may include that the contact force exerted on the battery module by the compensating element may be adjusted in a precise manner allowing for a more secure mounting arrangement.

Optionally in some examples, including in at least one preferred example, the mounting arrangement may further comprise a engagement mechanism adapted to counteract rotation of the mounting element by being arranged such that rotation of the mounting element relative to the housing is blocked due to the mounting element engaging the engagement mechanism. A technical benefit may include that rotation of the mounting element during installation may be prevented, thereby enabling the mounting element to guide the compensating element allowing for the compensating element to more securely engage the battery module. Another technical benefit may include that the mounting element may be fixated to the housing without welding, allowing a more space efficient mounting arrangement. Another technical benefit may include that the mounting element may be slightly rotated and/or moved in a plane orthogonal to the mounting axis to compensate for initial misalignment between the housing and the battery module, e.g. mounting holes in the battery module. Another technical benefit may include that said movement may enable coaxial alignment with a mounting interface, for example a depression, provided on the battery module.

Optionally in some examples, including in at least one preferred example, the engagement mechanism may comprise one or more blocking element adapted to be fix relative to the housing and to engage the mounting element to block rotation of said mounting element. A technical benefit may include that the mounting element may be fixated to the housing without welding, allowing a more space efficient mounting arrangement. Another technical benefit may include that the mounting element may be slightly rotated and/or moved in a plane orthogonal to the mounting axis to compensate for initial misalignment between the housing and the battery module, e.g. mounting holes in the battery module. Another technical benefit may include that said movement may enable coaxial alignment with a mounting interface, for example a depression, provided on the battery module.

Optionally in some examples, including in at least one preferred example, the mounting element may be adapted to be welded onto the housing. A technical benefit include that the mounting element does not rotate when subjected to a load, making the mounting arrangement more secure even when subjected to large loads. Another technical benefit may include that the welded mounting element may accommodate for adjustment of the compensating element in a secure manner, preferably also by the application of torque from the outside of the housing.

Optionally in some examples, including in at least one preferred example, the mounting arrangement may further comprise a cover member adapted to be arranged on the first side of the housing and be fixated to the housing by the fastening element. A technical benefit may include that the cover member clamps the compensating element against the battery module, further improving the stability of the mounting arrangement.

Optionally in some examples, including in at least one preferred example, the mounting arrangement may further comprise a sealing member adapted to seal between the cover member and the first side. A technical benefit may include that water, dirt or air may be prevented from entering inside the housing to the battery module.

Optionally in some examples, including in at least one preferred example, the cover member may comprise a cover through-hole and the fastening element may be adapted to extend through said cover through-hole upon engaging the battery module. A technical benefit may include that that the cover member may be fixated into position by means of the fastening element, whereby less operations are required to mount the components of mounting arrangement to the battery module and housing.

Optionally in some examples, including in at least one preferred example, the fastening element may comprise a head portion adapted to exert a contact force on an outer surface of the cover member upon engaging the battery module, the outer surface being arranged to face away from the first side of the housing. A technical benefit may include that the cover member may be fixated in a non-complex manner and without use of additional fastening means.

Optionally in some examples, including in at least one preferred example, the compensating element may comprise a through-going compensator aperture and the fastening element may be adapted to extend through said compensator aperture upon engaging the battery module. A technical benefit may include that the compensating element is fixated in a simple manner with few operations.

Optionally in some examples, including in at least one preferred example, the mounting arrangement may further comprise a sealing element adapted to seal between the fastening element and the cover member. A technical benefit may include that the risk for water, dirt or air entering into the housing via a space between the fastening element and the cover member is mitigated.

According to a second aspect of the disclosure, a mounting system for an energy storage system such as an energy storage system of a vehicle, marine vessel or motor, or such as an energy storage of a stationary system such as a building and/or a stationary machinery is provided. The mounting system is adapted to support one or more battery modules, the mounting system comprises a mounting structure comprising a housing, and one or more mounting arrangement of any of the herein described examples for mounting the one or more battery modules to the housing. The second aspect of the disclosure may seek to achieve a simpler manner of mounting a battery module to a mounting structure. A technical benefit may include that the compensating element may allow for a gap between the parts to be compensated prior to battery module being fixated to the mounting structure. Another technical benefit may include that the mounting element and the compensating element can be mounted beforehand and that a gap can be compensated by adjustment from the outer side of the housing making the mounting operation easier, faster and more user friendly.

Optionally in some examples, including in at least one preferred example, the one or more mounting arrangement may comprise at least one mounting arrangement adapted to engage a first side surface of a battery module to mount said battery module to the housing and wherein, preferably, the mounting system may further comprise at least one fastening member adapted to engage a second side surface of the said battery module opposite to the first side surface to mount said battery module to the housing. A technical benefit may include that conventional fastening members without compensating functionality may be utilized in combination with mounting arrangements allowing for a more cost-efficient and time efficient mounting of the battery module.

Optionally in some examples, including in at least one preferred example, the mounting system may be further adapted to support a plurality of battery modules arranged in a stacked configuration, whereby the mounting system may comprise a plurality of mounting arrangements for mounting the plurality of battery modules to the housing. A technical benefit may include that multiple battery modules may be mounted to the housing in a simple and cost-efficient manner.

According to a third aspect of the disclosure a vehicle may be provided. The vehicle may comprise one or more battery modules and a mounting system of any of the examples described herein. The third aspect of the disclosure may seek to achieve a more simple manner of mounting a battery module to a mounting structure. A technical benefit may include that the compensating element may allow for a gap between the parts to be compensated prior to battery module being fixated to the mounting structure. Another technical benefit may include that the mounting element and the compensating element can be mounted beforehand and that a gap can be compensated by adjustment from the outer side of the housing making the mounting operation easier, faster and more user friendly.

According to a fourth aspect of the disclosure a method for mounting a battery module to a housing of a mounting structure with a mounting arrangement of any of the examples described herein is provided. The method comprises positioning the battery module in the housing, fixating the mounting element relative to the housing on the second side of the housing, abutting the compensating element to an outer surface of the battery module, and engaging the fastening element from the first side of the housing with the battery module to fixate the compensating element such that the battery module is fixated at a distance from the second side. The fourth aspect of the disclosure may seek to achieve a more simple manner of mounting a battery module to a mounting structure. A technical benefit may include that the compensating element may allow for a gap between the parts to be compensated prior to battery module being fixated to the mounting structure. Another technical benefit may include that the mounting element and the compensating element can be mounted beforehand and that a gap can be compensated by adjustment from the outer side of the housing making the mounting operation easier, faster and more user friendly.

Optionally in some examples, including in at least one preferred example, the method may further comprise mounting the compensating element to the mounting element to adjustably engage the battery module.

Optionally in some examples, including in at least one preferred example, the method may further comprise arranging the cover member on the first side of the housing, and fixating the cover member to the housing with the fastening element. A technical benefit may include that the cover member clamps the compensating element against the battery module, further improving the stability of the mounting arrangement.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary vehicle comprising a mounting system according to an example.

FIG. 2 is a perspective view of a mounting system according to an example.

FIG. 3A is a perspective cross-section view of a mounting arrangement according to an example.

FIG. 3B is a cross-section of the mounting arrangement of FIG. 3A from a perspective view.

FIG. 4 is a cross-section view of a mounting arrangement according to an example.

FIG. 5 is a cross-section view of a mounting arrangement according to an example.

FIG. 6 is a cross-section view of a mounting arrangement according to an example.

FIG. 7 is a schematic flow chart of a method for mounting a battery module to a housing of a mounting structure according to an example.

FIG. 8 is a schematic flow chart of a method for mounting a battery module to a housing of a mounting structure according to an example.

### DETAILED DESCRIPTION

The detailed description set forth below provides information and examples of the disclosed technology with sufficient detail to enable those skilled in the art to practice the disclosure.

Electrically propelled vehicles, i.e. vehicles that are propelled by means of an electrical motor commonly requires energy storage units in the form of batteries to power the electrical motor. The batteries are associated with challenges as they are heavy and space consuming and requires particular mounting systems for mounting the batteries to the vehicle.

Such mounting systems commonly include a mounting structure to be mounted to a chassis of the vehicle. In order to shield the batteries from the outside environment, provide structural stability and crash safety, the mounting structure commonly includes a housing in which the batteries may be arranged when mounted. Due to shifting tolerances both in the batteries and in the housing, brackets such as L-brackets or particular adjustable fastening arrangements has been used in order to fixate the batteries, commonly provided as battery modules, to the housing. The use of battery modules mounted to the housing allows for easily adaptable and serviceable systems. A challenge with the existing solutions is that they either require complex and expensive adjustable fastening arrangements or a time consuming and complex mounting method.

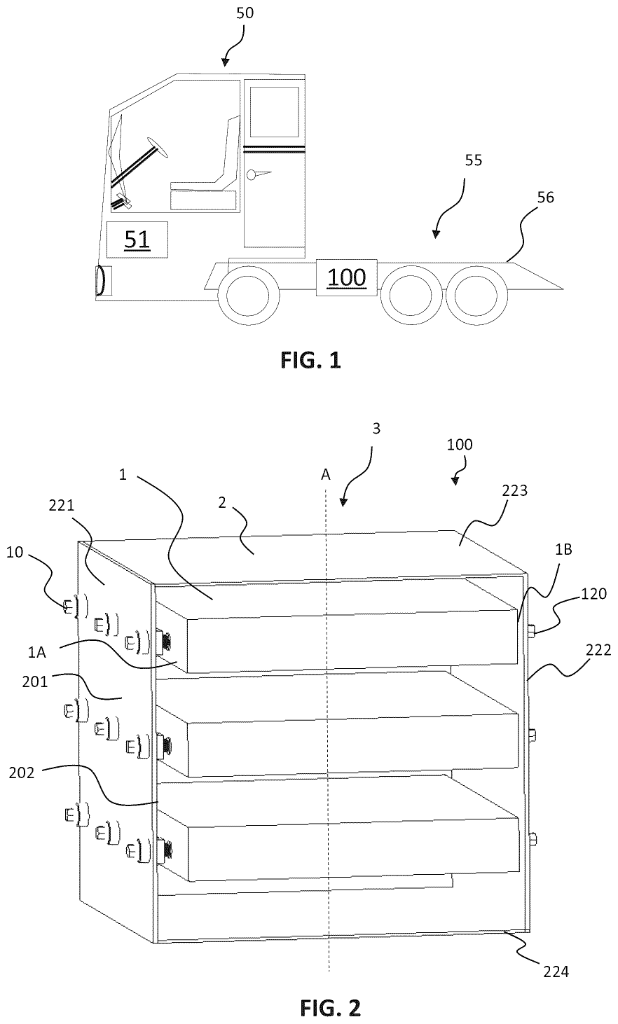

FIG. 1 is an exemplary vehicle 50 comprising a mounting system 100 according to an example. In the depicted example, the vehicle 50 is a truck but it may be envisioned that the vehicle may be any type of vehicle. Preferably, the vehicle may be a heavy-duty vehicle, such as truck, bus or construction equipment, among other vehicle types. It may also be envisioned that the mounting system 100 is utilized for a marine vessel such as a boat or a a motor and preferably an electrical motor configured to be powered by the battery modules to be mounted in the mounting system. It may also be envisioned that the mounting system 100 may be utilized for a stationary system such as a building and/or a stationary machinery. Accordingly, the mounting system may be for a vehicle 50, marine vessel, motor or a stationary system including a building and/or a stationary machinery. The mounting system 100 may be for an energy storage system of such a vehicle 50, marine vessel, motor or stationary system.

The vehicle 50 may comprise an electric motor 51 configured to propel the vehicle 50. The vehicle 50 may comprise a chassis 55 and the mounting system 100 may be adapted to be mounted to said chassis 55. In the depicted example, the chassis 55 may comprise a frame 56. Advantageously, the mounting system 100 may be adapted to be mounted to said frame 56.

FIG. 2 depicts the mounting system 100 in further detail. The mounting system 100 is for the vehicle 50. The mounting system 100 may be adapted to support one or more battery modules 1. The mounting system may comprise a mounting structure 3. The mounting structure 3 may comprise a housing 2. Although it is only described with reference to battery modules 1, it may be envisioned that the mounting system and mounting arrangement(s) described herein may be used for other components than battery modules. The energy storage system may comprise the one or more battery modules 1.

The mounting system 100 may comprise one or more mounting arrangements 10 for mounting the one or more battery modules 1 to the housing 2. Thus, the vehicle 50 may comprise one or more battery modules 1 and the mounting system 100.

The design and functionality of battery modules are well-known for the skilled person and will not be described in lengthy detail. It may however be envisioned that each battery module 1 comprises one or more battery cells and electrical connections for connecting the battery module 1 to an electrical consumer. In one example, the battery module 1 may be configured to power the electrical motor 51 of the vehicle 50. Hence, the electrical consumer may be the electrical motor 51 of the vehicle 50. It may also be envisioned that battery module 1 is configured to power a plurality of consumers including the electrical motor 51 and electrically powered auxiliaries.

The mounting structure 3 may be configured to be mounted to the chassis 55 of the vehicle 50 and preferably the frame 56 of the chassis 55. In one example, the mounting structure 3 may comprise an interface adapted to be mounted to the chassis 55 by means of one or more fasteners. As the skilled person realizes, the mounting structure 3 may be mountable to the chassis 55 in a multitude of ways readily available and commonly known.

The housing 2 may be configured to accommodate the one or more battery modules 1. The housing 2 may form a container for the one or more battery modules 1. In the depicted example, the housing 2 forms a first side wall 221 and a second side wall 222. The second side wall 222 may be arranged opposite to the first side wall 221. The one or more battery modules 1 may be mounted between the first side wall 221 and the second side wall 222.

In one example, the housing 2 may comprise a third side wall 223 and a fourth side wall 224. The third side wall 223 and the fourth side wall 224 may be arranged substantially perpendicular to the first side wall 221 and the second side wall 222. The third and side wall 223 and the fourth side wall 224 may connected the first side wall 221 and the second side wall 222. The fourth side wall 224 may be arranged opposite to the third side wall 223. The third side wall 223 and the fourth side wall 224 may extend substantially parallel to the one or more battery modules 1. The first, second, third and fourth side wall may together form a rectangular structure. Although the housing is depicted as a rectangular housing, the housing may depending on the requirements of the implementation be in any suitable shape and preferably in a shape allowing it to provide sufficient protection for the one or more battery modules 1.

In one example, the housing 2 may be provided with a front cover. In one example, the housing 2 may be provided with a rear cover. The front cover and/or the rear cover may be removably mounted to housing 2 and/or movable relative to the housing 2 to control access to the interior of the housing 2.

Further referencing FIG. 2, the one or more mounting arrangement 10 may comprise at least one mounting arrangement 10 adapted to engage a first side surface 1A of a battery module 1 to mount the battery module 1 to the housing 2. In the depicted example, each battery module 1 is mounted to the housing 2 with a plurality, for example three, of mounting arrangements 10 engaging the first side surface 1A of the battery module 1.

As will be described with reference to the subsequent figures, the mounting arrangement 10 may enable the battery module to be mounted at an adjustable distance from the second side 202. Due to this functionality being provided by the mounting arrangement(s), conventional, cheaper and more readily available fastening members 120 may be utilized for engaging other sides of the one or more battery modules 1 and fixing said sides to the housing 2. It may however be envisioned mounting arrangements 10 being utilized for this purpose as well. In the depicted example, the mounting system 100 comprises at least one fastening member 120. The at least one fastening member 120 may be adapted to engage a second side surface 1B of the battery module 1 to mount said battery module 1. The second side surface 1B may be opposite to the first side surface 1A.

In the example depicted in FIG. 2, the first side surface 1A of the battery module 1 faces the first side wall 221 of the housing 2. The at least one mounting arrangement 10 may extend through said first side wall 221 and engage the battery module 1 to mount said battery module 1 to the first side wall 221. Each mounting arrangement 10 may extend through a hole in the housing 2, e.g. in the first side wall 221. In the depicted example, the second side surface 1B of the battery module 1 faces the second side wall 222 of the housing 2. The at least one fastening member 120 may extend through said second side wall 222 of the housing 2. The at least one mounting fastening member 120 may extend through said second side wall 222 and engage the battery module 1 to mount said battery module 1 to the second side wall 222. Each fastening member 120 may extend through a hole in the housing 2, e.g. the second side wall 222.

The mounting system 100 may be adapted to support a plurality of battery modules 1. In the depicted example, the mounting system 100 is adapted to support three battery modules 1. The plurality of battery modules 1 may be arranged in a stacked configuration. Accordingly, the plurality of battery modules 1 may be arranged in parallel to each other and distributed along a common center axis A.

As depicted in FIG. 2, the housing 2 may be adapted to house the plurality of battery modules 1 in a stacked configuration such that the battery modules 1 are distributed along a common center axis A and at distances from each other along said common center axis A.

In the depicted examples, the plurality of battery modules 1 are arranged one on top of the other but it may be envisioned that a plurality of battery modules 1 are arranged side by side.

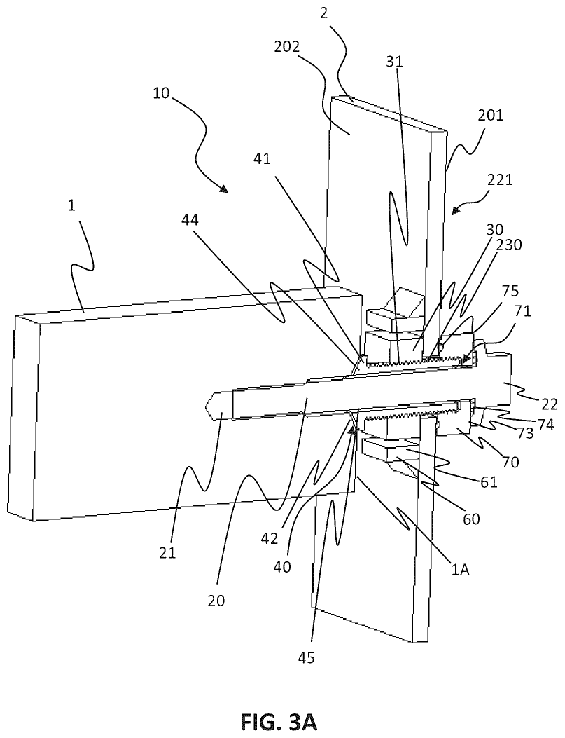

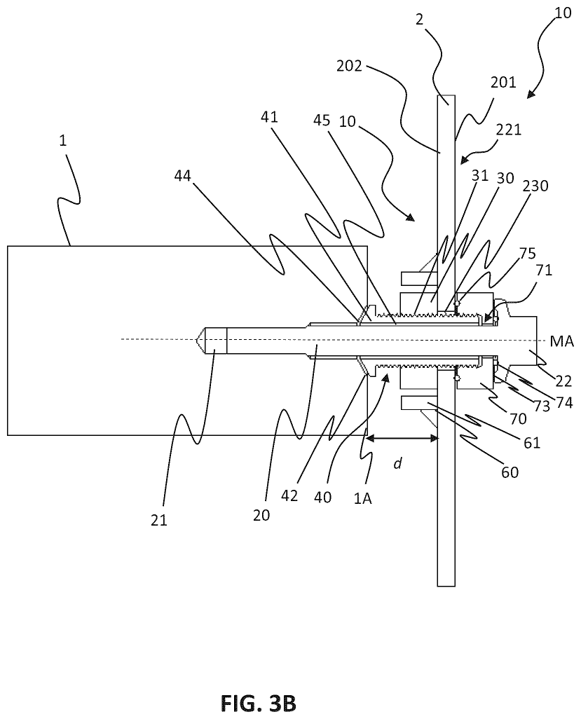

FIGS. 3A-6 depict mounting arrangements 10 for mounting a battery module 1 to the housing 2 of the mounting structure 3 according to the present disclosure according to various examples. Notably, albeit features may be described herein with reference to a particular example, the features may be implementable in any of the herein described examples unless otherwise is stated.

The mounting arrangement 10 may comprise a fastening element 20. The fastening element 20 may be adapted to engage the battery module 1. The fastening element 20 may be adapted to engage the battery module 1 from a first side 201 of the housing 2. The first side 201 may be facing away from the battery module 1.

The mounting arrangement 10 may comprise a mounting element 30. The mounting element 30 may be adapted to be fixed relative to the housing 2. The mounting element 30 may be adapted to be arranged on a second side 202 of the housing 2. The mounting element 30 may be adapted to engage the housing 2 on the second side 202 of the housing 2. The second side 202 of the housing 2 may face the battery module 1. As will be described in further detail with reference to FIGS. 3A-6, the mounting element 30 may be adapted to be fixed relative to the housing 2 for example by means of being fixated to the housing 2 for example by means of welding or being clamped against the housing 2.

The mounting arrangement 10 may comprise a compensating element 40. The compensating element 40 may be mounted to the mounting element 30. The compensating element 40 may be adapted to abut to an outer surface of the battery module 1. In the depicted example, the outer surface of the battery module 1 is the first side surface 1A of the battery module 1. The compensating element 40 may be adapted to be fixated relative to the housing 2 by the fastening element 20 such that the battery module 1 is fixated at a distance d from the second side 202.

The distance d may extend along a mounting axis MA of the mounting arrangement 10. Further, the fastening element 20 and/or the compensating element 40 may extend along said mounting axis MA. Preferably, the first side 201 and the second side 202 of the housing 2 may extend substantially perpendicular to the mounting axis MA. The first side 201 and the second side 202 may be substantially parallel. The first side 201 may form an outer surface of the housing 2 facing away from the battery module 1. The second side 202 may form an outer surface of the housing 2 facing the battery module 1.

The housing 2 may comprise a mounting hole 230. The mounting hole 230 may be in the form of a through-hole extending between the first side 201 and the second side 202. The mounting hole 230 may extend along the mounting axis MA.

The fastening element 20 may be adapted to extend from the first side 201 through said mounting hole 230 and into engagement with the battery module 1.

Although it may be envisioned that the mounting arrangement 10 may be configured to mount a battery module 1 to any part of the housing 2; in the depicted example, the mounting arrangement 10 is configured to mount a battery module 1 to the first side wall 221 of the housing 2. The first side 201 may thus be a first side of the first side wall 221 and the second side 202 may be a second, opposite, side of the first side wall 221.

The mounting element 30 may be adapted to be fixed relative to the housing 2 on the second side 202. The mounting element 30 may comprise a mounting element aperture 31 extending along the mounting axis MA. The compensating element 40 may be inserted in said mounting element aperture 31 to abut to the outer surface of the battery module 1. Upon mounting of the battery module 1, the compensating element 40 may be mounted to the mounting element 30 by insertion of the compensating element 40 through the mounting element aperture 31 until end portion of said compensating element 40 abuts to the battery module 1, the outer surface of the battery module 1. Upon mounting of the fastening element 20 into the mounting hole 230, the fastening element 20 may be adapted to exert a clamping force onto the compensating element 40 clamping the compensating element 40 against the battery module 1 and fixating the battery module 1 relative to the housing 2.

The mounting element 30 may be provided in the form of a nut, collar, bushing or any other type of suitable element readily available for the skilled person. The mounting element 30 may be adapted to be directly, for example via welding or fasteners, or indirectly, for example via contact pressure exerted by other components of the mounting arrangement, fixated relative to the housing 2, i.e. the second side 202 of the housing 2. The mounting element 30 may be substantially annular and/or envelop the mounting hole 230 on the second side 202 of the housing 2.

The compensating element 40 may be arranged along the mounting axis MA. Advantageously, the compensating element 40 may be arranged to extend through the mounting element 30 and/or the mounting hole 230. The compensating element 40 may comprise a proximal end and a distal end relative to the extension of the mounting axis MA. The proximal end may be adapted to extend on the first side 201 of the housing 2. The distal end may be adapted to extend on the second side 202 of the housing 2. The distal end may be adapted to abut to the battery module 1.

The compensating element 40 may be provided in the form of a sleeve element. The compensating element 40 may comprise a through-going compensator aperture 45. The fastening element 20 may be adapted to extend through the compensator aperture 45 upon engaging the battery module 1.

The compensator aperture 45 may extend along the mounting axis MA. The compensator aperture 45 may coincide with the mounting element aperture 31.

The compensating element 40 may comprise an end portion 41. The end portion 41 may comprise an end surface 42. The end surface 42 may be adapted to engage the battery module 1. The end portion 41 may be considered the distal end portion.

The fastening element 20 may be any form of fastening element suitable for engaging a battery module 1. Preferably, the fastening element 20 may be a threaded fastening element such as a screw or bolt, but it may be envisioned that for example a guiding pin in combination with a locking arrangement may be utilized.

The fastening element 20 may be adapted to engage a corresponding battery module hole 21 provided in the battery module 1. The battery module hole 21 may be a threaded hole with threads adapted to be engageable by the treads of the fastening element 20.

The compensating element 40 and the mounting element 30 may be in adjustable engagement. Advantageously, the compensating element 40 may be adjustable relative to the mounting element 30 to enable the compensating element 40 to properly engage the battery module 1. In one example, this may be achieved by the mounting element 30 and the compensating element 40 forming a threaded connection. In one example, the mounting element 30 may be provided with threading and the compensating element 40 may be provided with threading such that the compensating element 40 and the mounting element 30 are in adjustable engagement. In one example, the mounting element 30 may be provided with threading and the compensating element 40 may be provided with threading such that the compensating element 40 is adjustable relative to the mounting element 30 for adjustably engaging the battery module 1. In one example, the mounting element aperture 31 may be provided with inner threading for adjustably engaging with the threading provided on the compensating element 40.

The mounting arrangement 10 may further comprise a cover member 70. The cover member 70 may be adapted to be arranged on the first side 201 of the housing 2. The cover member 70 may be adapted to engage the housing 2 by the fastening element 20. The cover member 70 may be arranged between the compensating element 40 and the fastening element 20 and may clamp the compensating element 40 against the battery module 1 upon the fastening element 20 engaging the battery module 1. Although it may be envisioned that the fastening element 20 may provide the clamping force directly onto the housing 2, the cover member 70 serves to improve the integrity of the housing 2 by for example covering the mounting hole 230 from the first side 201.

The fastening element 20 may be adapted to clamp the cover member 70 against the housing 2, thereby clamping the compensating element 40 against the battery module 1. The clamping force exerted by the fastening element 20 may also cause the compensating element 40 to press against the battery module 1 via the mounting element 30.

The cover member 70 may comprise a cover through-hole 71. The fastening element 20 may be adapted to extend through the cover through-hole 71 upon engaging the battery module 1. The cover through-hole 71 may extend along the mounting axis MA. The cover through-hole 71 may be co-axial with the compensator aperture 45.

In one example, the cover through-hole 71 may be provided with threading adapted to engage threading provided on the compensating element 40. According to such an example, the cover member 70 may be mounted to the proximal portion of the compensating element 40 by means of said threadings.

The fastening element 20 may comprise a head portion 22. The head portion 22 may be adapted to exert a contact force on an outer surface 73 of the cover member 70 upon engaging the battery module 1. The outer surface 73 may be arranged to face away from the first side 201 of the housing 2.

The outer surface 73 may extend substantially perpendicular to the mounting axis MA. The fastening element 20 may have a distal portion and a proximal portion along the mounting axis MA. The proximal portion may comprise the head portion 22. The distal portion may be adapted to engage the battery module 1.

The head portion 22 may comprise a surface arranged to face the outer surface 73. Said surface may extend substantially perpendicular to the mounting axis MA. Said surface may be formed by a radial flange of the head portion 22.

In one example, the mounting arrangement 10 may comprise a sealing member 75. The sealing member 75 may be adapted to seal between the cover member 70 and the first side 201 of the housing 2. The sealing member 75 may be provided in the form of a gasket. The sealing member 75 may be configured to be arranged in sealing contact with the cover member 70 and the first side 201. Advantageously, the sealing member 75 is provided on the cover member 70. The sealing member 75 may thus be mounted to the cover member 70. It may however be envisioned that the sealing member 75 is attached to the first side 201 of the housing 2 such that the cover member 70 is clamped against the sealing member 75 to form the seal. It may also be envisioned that the sealing member 75 may be attached to a portion of compensating element 40 being arranged on the first side of the housing 2 or a portion of the mounting element 20 being arranged on the first side of the housing 2.

The sealing member 75 may be configured to seal the mounting hole 230 from the exterior of the first side 201. The sealing member 75 may thus be arranged to envelop the mounting hole 230. In one example, the sealing member 75 may be arranged such that it is compressed between the housing 2 and the cover member 70.

In one example, the mounting arrangement 10 may comprise a sealing element 74. The sealing element 74 may be adapted to seal between the fastening element 20 and the cover member 70. The sealing element 74 may be provided in the form of a gasket. The sealing element 74 may be configured to be arranged in sealing contact with the cover member 70 and the fastening element 20. Advantageously, the sealing element 74 is provided on the cover member 70. Thereby, the fastening element 20 may be provided in the form of a conventional fastening element 20. The sealing element 74 may thus be mounted to the cover member 70. It may however be envisioned that the sealing element 74 is attached to the fastening element 20 such that the fastening element 20 clamps the cover member 70 against the cover member 70 to form the seal. In one example, the sealing element 74 may be arranged on the head of the fastening element 20. According to such an example, the fastening element 20 may be provided in the form of a sealing screw. The sealing element 74 may be configured to seal the compensator aperture 45 from the exterior of the first side 201. The sealing element 74 may thus be arranged to envelop the compensator aperture 45.

The mounting of the battery module 1 to the housing 2 may in one example be described in the following. The mounting element 30 may be fixated relative to the housing 2 on the second side 202 of said housing 2. The compensating element 40 may be mounted to the mounting element 30, preferably by means of insertion into the mounting element aperture 31. Depending on the design of the compensating element 40, the compensating element 40 may be mounted both from a direction along the mounting axis MA from the first side 201 towards the second side 202 or from the second side 202 towards the first side 201.

The compensating element 40 may be adjusted along the mounting axis MA towards the battery module 1 until the end portion 41 of said compensating element 40 abuts to the battery module 1. The adjustment may be performed by means of rotation of the compensating element 40 due to the threaded connection between the mounting element 30 and the compensating element 40. This may be particularly advantageous in cases where the mounting element 30 is directly fixated to the housing 2.

In other examples, the battery module 1 may be arranged to abut to the compensating element 40 and the mounting element 30 may adapted to be adjusted relative to compensating element 40 along the mounting axis MA to come into contact with the housing 2 to thereby fixate the compensating element 40.

The cover member 70 may be aligned with the compensator aperture 45 and clamped into position by the insertion of the fastening element 20 into the compensator aperture 45 and through the cover through-hole 71. The fastening element 20 may be brought into engagement with the battery module 1, e.g. the battery module hole 21, thereby fixating the compensating element 40 into position and the battery module 1 at the distance d from the second side 202. The fastening element 20 may be rotated into position due to the threaded connection between the fastening element 20 and the battery module hole 21.

The design of the components of the mounting arrangement 10 may be adapted in accordance with the intended implementation and requirements. FIGS. 3A-6 depict examples of a mounting arrangement 10 according to the present disclosure.

FIGS. 3A-3B depict a cross-section of a mounting arrangement 10 according to one example in a perspective view and a conventional cross-section view.

In the depicted example, the end portion 41 of the compensating element 40 may be particularly adapted to engage the battery module 1 to improve upon the stability of the mounting of the battery module 1.

In the depicted example, the end portion 41 may comprise a conical portion 44. The conical portion 44 may be provided with the end surface 42 of the compensating element 40. As aforementioned, the distal end portion of the compensating element 40 may comprise the end portion 41. The end surface 42 may extend substantially orthogonally to the mounting axis MA. The conical portion 44 may taper distally relative to the mounting axis MA towards said end surface 42.

Further referencing FIGS. 3A-3B, the battery module 1 may comprise a corresponding conical depression adapted to receive the conical portion 44. The battery module hole 21 may be arranged in said conical depression.

As aforementioned, the mounting element 30 may be adapted to be fixed to the housing 2. There is however a risk due to being subjected to loads and torques that the mounting element 30 starts to rotate relative to the housing 2 which in turn may cause the compensating element 40 to not properly engage with the battery module 1. To address this, an engagement mechanism 60 may be provided. The engagement mechanism 60 may be arranged such that rotation of the mounting element 30 relative to the housing 2 is blocked due to the mounting element 30 engaging the engagement mechanism 60.

To accommodate for shifting tolerances in the mounting arrangement 10, the engagement mechanism 60 may be adapted to enable relative movement and/or rotation to the housing 2 up to a certain limit. Hence, the engagement mechanism 60 may be adapted to engage the mounting element 30 upon the mounting element 30 rotating up to an angle in a first rotation direction and/or a second, opposite, rotation direction. Additionally or alternatively, the engagement mechanism 60 may be adapted to enable relative movement between the mounting element 30 and the housing 2 in a direction extending along the second side of the housing 2. Thereby, the mounting element 30 may be adjustable to compensate for misalignments between the housing 2 and the mounting element 30 during mounting of the compensating element 40 and/or the fastening element 20.

The mounting of the mounting arrangement may thus be performed by means of an operator mounting the compensating element 40 into the mounting element 30 from the second side of the housing 2. The compensating element 40 may be adjusted relative to the mounting element 30 towards the battery module 1 until the compensating element 40 engages the battery module 1 and until the mounting element 30 is blocked by the engagement mechanism 60.

In the depicted example, the engagement mechanism 60 may comprise one or more blocking element 61. The one or more blocking element 61 may be adapted to be fix relative to the housing 2. The one or more blocking element 61 may be adapted to engage the mounting element 30 to block rotation of the mounting element 30.

The one or more blocking element 61 may be fixated to the first side wall 221 same as the mounting element 30. In the depicted example, the one or more blocking element 61 may be welded to the housing 2 but it may be envisioned that any type of conventional fastener may be used such as adhesive, screws, bolts etc.

The one or more blocking element 61 are adapted and arranged such that rotation of the mounting element 30 in a rotation direction relative to the housing 2 up to a certain point will cause the mounting element 30 to engage at least one of the one or more blocking element 61. Said blocking element 61 will prevent any further rotation of the mounting element 30 in said rotation direction.

To improve the reliability of the engagement mechanism 60, the mounting element 30 may be designed in a manner which enables proper engagement with the engagement mechanism 60. In the depicted example, this is achieved by means of the mounting element 30 being provided as a square nut. The squared shape causes the corner portions of the mounting element 30 to engage the one or more blocking elements 60 in a reliable manner. Alternatively, the mounting element 30 may for example be provided with protrusions or projections for the same purpose.

In the depicted example, the engagement mechanism 60 comprises a first and second blocking element 61. The first and second blocking element 61 may be arranged on opposite sides of the mounting element 30.

The combination of the conical configuration of the compensating element and an engagement mechanism in accordance with the above may be particularly advantageous. This due to engagement mechanism allowing for the mounting element to be slightly moved and rotated prior to the compensating element being brought into contact with the battery module. This will allow alignment to achieve a desirable engagement between the conical surface of the compensating element 40 with the corresponding conical depression of the battery module 1.

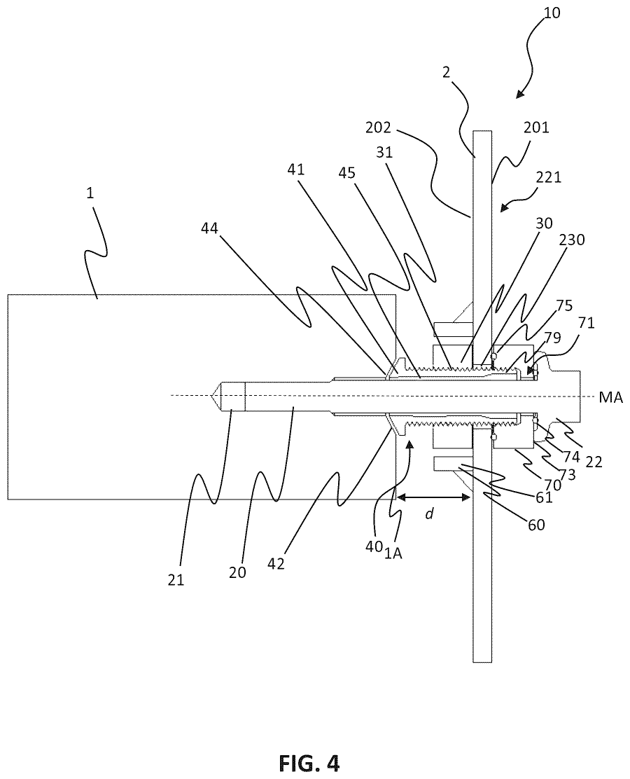

FIG. 4 depicts a cross-section of an exemplary mounting arrangement 10. The mounting arrangement 10 may share the features of the mounting arrangement of FIGS. 3A-3B unless otherwise is stated.

Referencing FIG. 4, the compensating element 40 may comprise a torque tool interface 79. The torque tool interface 79 may be configured to be engaged by a torque tool to enable rotation of the compensating element 40 about the mounting axis MA and consequent displacement of the compensating element 40 along the mounting axis MA. The proximal end portion of the compensating element 40 may comprise the torque tool interface 79. The torque tool interface 79 may face away from the first side 201 of the housing 2 such that it may be engaged by the torque tool from said first side 201 of the housing 2. The torque tool interface 79 may comprise a key grip such as a hex key grip.

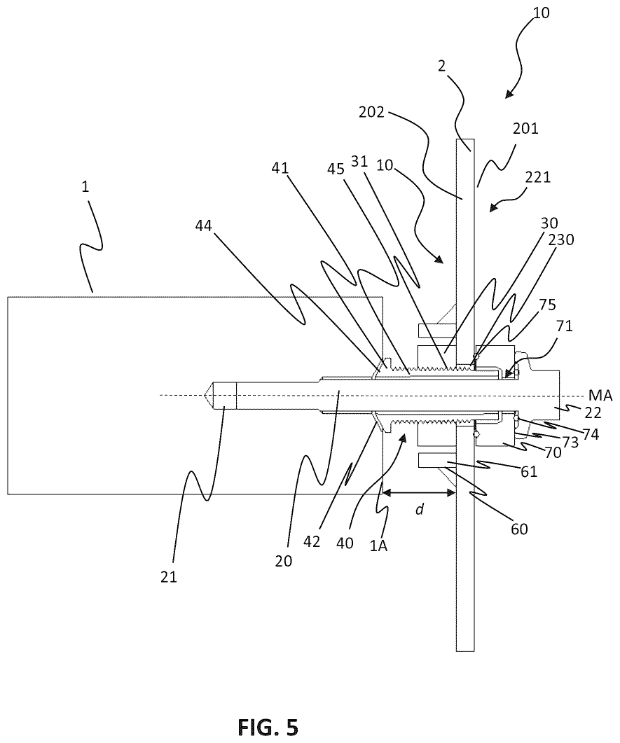

FIG. 5 depicts a cross-section of an exemplary mounting arrangement 10. The mounting arrangement 10 may share the features of the mounting arrangement of FIGS. 3A-3B unless otherwise is stated.

Referencing FIG. 5, the proximal end portion of the compensating element 40 may be arranged to protrude on the first side of the housing 2 when the mounting arrangement is mounted to the housing 2. In the depicted example, the cover member 70 is arranged to at least partially cover a proximal end surface of the proximal end portion of the compensating element 40. Advantageously, the cover member 70 may be arranged to cover the engagement surfaces of the torque tool interface 79. The cover member 70 may thus be positioned on the proximal end portion of the compensating element 40 and then be fixated in position by means of the fastening element 20.

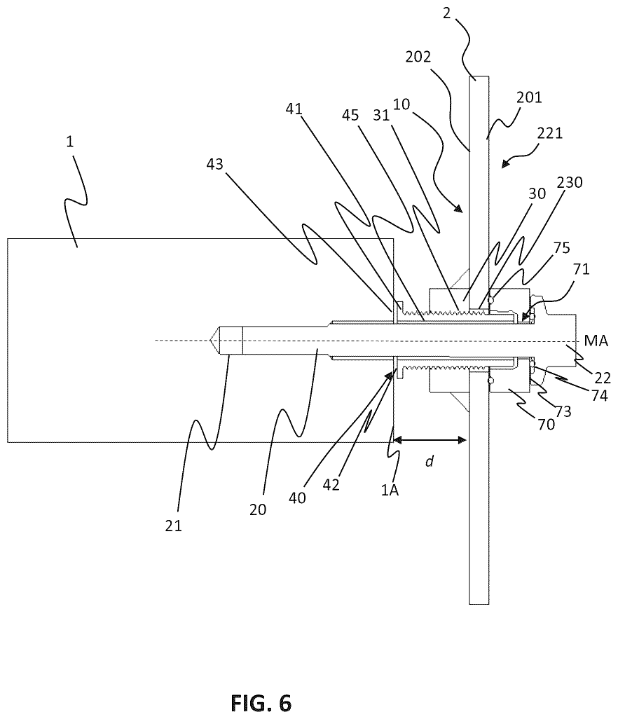

FIG. 6 depicts a cross-section of an exemplary mounting arrangement 10. The mounting arrangement 10 may share the features of the mounting arrangement of FIGS. 3A-3B unless otherwise is stated.

As depicted in FIG. 6, the mounting element 30 may be adapted to be welded onto the housing 2. In the depicted example, the mounting element 30 is welded onto the first side wall 221, e.g. the second side 202 of the first side wall 221.

Due to the weld not enabling relative movement between the mounting element 30 and the housing 2, the design of the compensating element 40 may differ. Referencing FIG. 6, the end portion 41 may comprise a flanged portion 43. The flanged portion 43 may be provided with the end surface 42. The flanged portion may be formed by a radial flange protruding in a radial direction relative to the mounting axis MA. The end surface 42 may extend substantially orthogonally to the mounting axis MA. The flanged portion 43 allows for a secure engagement between the battery module 1 and the compensating element 40 less reliant on a precise alignment between the battery module 1 and the compensating element 40.

According to the depicted example, the battery module 1 may be mounted to the housing 2 by means of the mounting arrangement 10 by the operator fixating the mounting element 30 to the housing 2. The compensating element 40 may then be mounted to the mounting element 30 and be adjusted relative to the mounting element 30 to engage the battery module 1. The compensating element 40 may be adjusted from the first side of the housing 2. The compensating element 40 may be fixed by means of the fastening element 20 and preferably by the cover member 70 together with the fastening element 20.

According to an aspect, a method for mounting the battery module 1 to the housing 2 of the mounting structure 3 with the mounting arrangement 10 is provided. The mounting arrangement may be the mounting arrangement 10 according to any one of examples described herein.

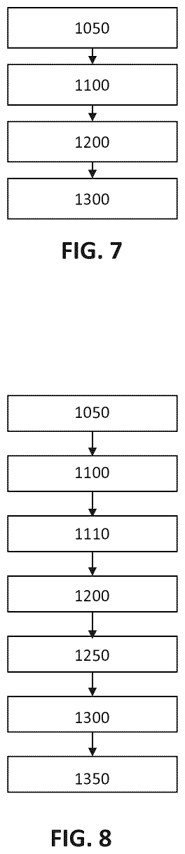

The method according to one example is schematically depicted in FIG. 7.

The method may comprise positioning 1050 the battery module 1 in the housing 2, arranging 1100 the mounting element 30 relative to the housing 2 on the second side 202 of the housing 2, abutting 1200 the compensating element 40 to an outer surface of the battery module 1, and engaging 1300 the fastening element 20 from the first side of the housing 2 with the battery module 1 to fixate the compensating element 40 such that the battery module 1 is fixated at a distance d from the second side 202.

FIG. 8 schematically depicts the method according to one example.

The method may comprise mounting 1110 the compensating element 40 to the mounting element 30.

The method may comprise arranging 1250 the cover member 70 on the first side 201 of the housing 2 and fixating 1350 the cover member 70 to the housing 2 with the fastening element 20.

In one example, wherein a mounting element 30 directly mounted to the housing 2 is utilized, the method may comprise fixating the mounting element 30 to the housing 2. In one example, the method may comprise fixating the mounting element 30 on the second side 202 of the housing 2. In one example, the method may comprise welding the mounting element 30 to the housing 2.

Further, the method may comprise adjusting the compensating element 40 relative to the mounting element 30 to engage the battery module 1 and fixating the compensating element 40 by means of the fastening element 20 and preferably also by means of the cover member 70.

In one example, wherein a mounting element 30 clamped onto to the housing 2 is utilized, the method may comprise mounting the engagement mechanism 60 to the housing 2. In one example, the method may comprise welding the engagement mechanism 60 to the housing 2 although it may be envisioned that other types of fastening may be utilized.

In one example, the method may comprise aligning the mounting element 30 and the compensating element 40 with the battery module such that the compensating element 40 is in engagement with the battery module 1 and the mounting element 30 engages the engagement mechanism 60 to secure the compensating element 40 and fixating the compensating element 40 and the mounting element 30 by means of the fastening element 20 and preferably also by means of the cover member 70. In one example, the mounting element 30 and the compensating element 40 may be rotated together such that the compensating element 40 is in engagement with the battery module 1 and the mounting element 30 engages the engagement mechanism 60 to secure the compensating element 40.

According to an aspect, a mounting arrangement, mounting system, vehicle and method according to any of the following examples is provided.
Example 1: A mounting arrangement (10) for mounting a battery module (1) to a housing (2) of a mounting structure (3), the mounting arrangement (10) comprising:
   a fastening element (20) adapted to engage the battery module (1) from a first side (201) of the housing (2) facing away from the battery module (1),
   a mounting element (30) adapted to be fixed relative to the housing (2) and arranged on a second side (202) of the housing (2) facing the battery module (1), and
   a compensating element (40) mounted to the mounting element (30), said compensating element (40) being adapted to abut to an outer surface of the battery module (1) and to be fixated relative to the housing (2) by the fastening element (20) such that the battery module (1) is fixated at a distance (d) from the second side (202).
Example 2: The mounting arrangement (10) of example 1, wherein the compensating element (40) comprises an end portion (41) with an end surface (42) adapted to engage the battery module (1).
Example 3: The mounting arrangement (10) of example 2, wherein the end portion (41) comprises a flanged portion (43) provided with the end surface (42).
Example 4: The mounting arrangement (10) of example 2, wherein the end portion (41) comprises a conical portion (44) provided with the end surface (42).
Example 5: The mounting arrangement (10) of examples 1-4, wherein the mounting element (30) and the compensating element (40) are provided with threading such that the compensating element (40) and the mounting element (30) are in adjustable engagement.
Example 6: The mounting arrangement (10) of examples 1-5, further comprising:
an engagement mechanism (60) adapted to counteract rotation of the mounting element (30) by being arranged such that rotation of the mounting element (30) relative to the housing (2) is blocked due to the mounting element (30) engaging the engagement mechanism (60).
Example 7: The mounting arrangement (10) of example 6, wherein the engagement mechanism (60) comprises one or more blocking element (61) adapted to be fix relative to the housing (2) and to engage the mounting element (30) to block rotation of said mounting element (30).
Example 8: The mounting arrangement (10) of examples 1-7, wherein the mounting element (30) is adapted to be welded onto the housing (2).
Example 9: The mounting arrangement (10) of examples 1-8, further comprising:
   a cover member (70) adapted to be arranged on the first side (201) of the housing (2) and be fixated to the housing (2) by the fastening element (20).
Example 10: The mounting arrangement (10) of example 9, further comprising:
   a sealing member (75) adapted to seal between the cover member (70) and the first side (201).
Example 11: The mounting arrangement (10) of example 9 or 10, wherein the cover member (70) comprises a cover through-hole (71) and the fastening element (20) is adapted to extend through said cover through-hole (71) upon engaging the battery module (1).
Example 12: The mounting arrangement (10) of example 11, wherein the fastening element (20) comprises a head portion (22) adapted to exert a contact force on an outer surface (73) of the cover member (70) upon engaging the battery module (1), the outer surface (73) being arranged to face away from the first side (201) of the housing (2).
Example 13: The mounting arrangement (10) of examples 1-12, wherein the compensating element (40) comprises a through-going compensator aperture (45) and the fastening element (20) is adapted to extend through said compensator aperture (45) upon engaging the battery module (1).
Example 14: The mounting arrangement (10) of examples 9-13, further comprising:
   a sealing element (74) adapted to seal between the fastening element (20) and the cover member (70).
Example 15: A mounting system (100) for an energy storage system such as an energy storage system of a vehicle (50), marine vessel or motor, or such as an energy storage system of a stationary system such as a building or a stationary machinery, the mounting system (100) being adapted to support one or more battery modules (1), the mounting system (100) comprising:
   a mounting structure (3) comprising a housing (2), and
   one or more mounting arrangement (10) of any of claims 1-14 for mounting the one or more battery modules (1) to the housing (2).
Example 16: The mounting system (100) of example 15, wherein the one or more mounting arrangement (10) comprises at least one mounting arrangement (10) adapted to engage a first side surface (1A) of a battery module (1) to mount said battery module (1) to the housing (2) and wherein, preferably, the mounting system (100) further comprises at least one fastening member (120) adapted to engage a second side surface (1B) of the said battery module (1) opposite to the first side surface (1B) to mount said battery module (1) to the housing (2).
Example 17: The mounting system (100) of example 15 or 16, being further adapted to support a plurality of battery modules (1) arranged in a stacked configuration, whereby the mounting system (100) comprises a plurality of mounting arrangements (10) for mounting the plurality of battery modules (1) to the housing (2).
Example 18: A vehicle (50) comprising one or more battery modules (1) and a mounting system (100) of examples 15-17.
Example 19. A method for mounting a battery module (1) to a housing (2) of a mounting structure (3) with a mounting arrangement (10) of examples 1-14, the method comprising:
   positioning (1050) the battery module (1) in the housing (2),
   arranging (1100) the mounting element (30) relative to the housing (2) on the second side (202) of the housing (2),
   abutting (1200) the compensating element (40) to an outer surface of the battery module (1), and
   engaging (1300) the fastening element (20) from the first side (201) of the housing (2) with the battery module (1) to fixate the compensating element (40) such that the battery module (1) is fixated at a distance (d) from the second side (202).
Example 20: The method of example 19, further comprising:
   mounting (1110) the compensating element (40) to the mounting element (30) to adjustably engage the battery module (1).
Example 21: The method of example 19 or 20, further comprising:
   arranging (1250) the cover member (70) on the first side (201) of the housing (2), and
   fixating (1350) the cover member (70) to the housing (2) with the fastening element (20).

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation. the scope of the disclosure being set forth in the following claims.

What is claimed is:

1. A mounting arrangement for mounting a battery module to a housing of a mounting structure, the mounting arrangement comprising:
a fastening element adapted to engage the battery module from a first side of the housing facing away from the battery module;
a mounting element adapted to be fixed relative to the housing and arranged on a second side of the housing facing the battery module; and
a compensating element mounted to the mounting element, the compensating element being adapted to abut to an outer surface of the battery module and to be fixated relative to the housing by the fastening element such that the battery module is fixated at a distance from the second side.

2. The mounting arrangement of claim 1, wherein the compensating element comprises an end portion with an end surface adapted to engage the battery module.

3. The mounting arrangement of claim 2, wherein the end portion comprises a flanged portion provided with the end surface.

4. The mounting arrangement of claim 2, wherein the end portion comprises a conical portion provided with the end surface.

5. The mounting arrangement of claim 1, wherein the mounting element and the compensating element are provided with threading such that the compensating element and the mounting element are in adjustable engagement.

6. The mounting arrangement of claim 1, further comprising:
an engagement mechanism adapted to counteract rotation of the mounting element by being arranged such that rotation of the mounting element relative to the housing is blocked due to the mounting element engaging the engagement mechanism.

7. The mounting arrangement of claim 6, wherein the engagement mechanism comprises a blocking element adapted to be fixed relative to the housing and to engage the mounting element to block rotation of the mounting element.

8. The mounting arrangement of claim 1, wherein the mounting element is adapted to be welded onto the housing.

9. The mounting arrangement of claim 1, further comprising:
a cover member adapted to be arranged on the first side of the housing and be fixated to the housing by the fastening element.

10. The mounting arrangement of claim 9, further comprising:
a sealing member adapted to seal between the cover member and the first side.

11. The mounting arrangement of claim 9, wherein the cover member comprises a cover through-hole and the fastening element is adapted to extend through the cover through-hole upon engaging the battery module.

12. The mounting arrangement of claim 11, wherein the fastening element comprises a head portion adapted to exert a contact force on an outer surface of the cover member upon engaging the battery module, the outer surface being arranged to face away from the first side of the housing.

13. The mounting arrangement of claim 1, wherein the compensating element comprises a through-going compensator aperture and the fastening element is adapted to extend through the compensator aperture upon engaging the battery module.

14. The mounting arrangement of claim 9, further comprising:
a sealing element adapted to seal between the fastening element and the cover member.

15. A mounting system for an energy storage system such as an energy storage system of a vehicle, marine vessel or motor, or such as an energy storage system of a stationary system such as at least one of a building and a stationary machinery, the mounting system being adapted to support a battery module, the mounting system comprising:
a mounting structure comprising a housing; and
the mounting arrangement of claim 1 for mounting the battery module to the housing.

16. The mounting system of claim 15, wherein the mounting arrangement comprises at least one mounting arrangement adapted to engage a first side surface of a battery module to mount the battery module to the housing and wherein, preferably, the mounting system further comprises at least one fastening member adapted to engage a second side surface of the battery module opposite to the first side surface to mount the battery module to the housing.

17. A vehicle comprising a battery module and the mounting system of claim 15.

18. A method for mounting a battery module to a housing of a mounting structure with the mounting arrangement of claim 1, the method comprising:
positioning the battery module in the housing;
arranging the mounting element relative to the housing on the second side of the housing;
abutting the compensating element to an outer surface of the battery module; and
engaging the fastening element from the first side of the housing with the battery module to fixate the compensating element such that the battery module is fixated at a distance from the second side.

19. The method of claim 18, further comprising:
mounting the compensating element to the mounting element.

20. The method of claim 18. further comprising:
arranging the cover member on the first side of the housing; and
fixating the cover member to the housing with the fastening element.
